(19) United States
(12) Patent Application Publication
(10) Pub. No.: US 2013/0170819 A1
(43) Pub. Date: Jul. 4, 2013

(54) SYSTEMS AND METHODS FOR REMOTELY MANAGING RECORDING SETTINGS BASED ON A GEOGRAPHICAL LOCATION OF A USER

(71) Applicants: Kim R. Dykeman, San Francisco, CA (US); Eric W. Grab, San Diego, CA (US)

(72) Inventors: Kim R. Dykeman, San Francisco, CA (US); Eric W. Grab, San Diego, CA (US)

(73) Assignee: UNITED VIDEO PROPERTIES, INC., Santa Clara, CA (US)

(21) Appl. No.: 13/340,282

(22) Filed: Dec. 29, 2011

(51) Int. Cl. H04N 5/76

(52) U.S. Cl. 386/299; 386/E05.001

(57) ABSTRACT

Systems and methods for remotely managing recording settings based on a geographical location of a user are provided. A determination is made that the user, associated with a user equipment device, is currently attending a live event. A video associated with the live event accessible by the user equipment device is identified. In response to identifying, an option for the user to select a recording setting of the user equipment device is generated for display on the mobile device. The user equipment device is caused to be programmed based on the user selection of the displayed option.

### BACKGROUND

Conventional systems enable a user to control a home recording device from a remote location using a mobile device. However, in these systems, the user of the mobile device has to manually determine whether or not a program has been scheduled for recording on the home recording device and after making this determination, the user has to make the desired recording adjustments for the program. Therefore, these conventional systems fail to intelligently enable management of the home recording device from the remote location using the mobile device.

### SUMMARY OF THE INVENTION

In view of the foregoing, systems and methods for remotely managing recording settings based on a geographical location of a user are provided. In particular, a live event which the user is currently attending is determined and a video transmission of the live event to a user equipment device is automatically identified. An option is presented on the mobile device, to enable the user to change a recording setting, of the user equipment device, corresponding to the video transmission.

In some embodiments, a user is determined to be attending a live event (e.g., a football game) with a mobile device (e.g., a mobile phone). In response to determining the user is attending the live event, a determination is made as to whether a video corresponding to the live event is scheduled for transmission to a user equipment device associated with the user (e.g., a home video recorder). The mobile device may request a list of scheduled recordings from the user equipment device to determine whether the video has previously been scheduled for recording on the user equipment device. In some implementations, when a recording of the video has not previously been scheduled for the user equipment device, the mobile device may present the user with an option to schedule the recording of the video. When a recording of the video has previously been scheduled for the user equipment device, the mobile device may present the user with an option to un-schedule the recording of the video and/or replace the recording with a different media asset recording.

In some embodiments, a comparison between the current time and the scheduled time of the video is performed with the mobile device. When the current time is near the scheduled end time of the video corresponding to the live event, the mobile device may determine whether the user is still attending (is located at) the live event. In response to determining the user is still attending the live event and that the current time is near the scheduled end time of the video corresponding to the live event, the mobile device may present an option to the user to extend the recording of the video on the user equipment device. In some embodiments, the user equipment device may automatically be instructed to extend a recording of the video corresponding to the live event when a greater than a predetermined number of users are still present (attending) the live event.

In some embodiments, the mobile device may determine that the user is not attending the live event (e.g., the user has left the premises of the live event) and that the current time is near the scheduled end time of the video corresponding to the live event. In response to this determination, the mobile device may present an option to the user to stop recording the video corresponding to the live event on the user equipment device.

In some embodiments, a mobile device may determine that a user, associated with a user equipment device, is currently attending a live event. The mobile device may identify whether a video associated with the live event is accessible by the user equipment device. For example, the mobile device may identify whether the video is accessible by the user equipment device based on media schedule information stored in a memory of the mobile device. In some implementations, the mobile device may identify whether the video is accessible by the user equipment device by transmitting a request to a remote server on which media schedule information is stored and receiving an indication from the remote server identifying whether the video is or is not accessible by the user equipment device. In response to identifying the video corresponding to the live event, the mobile device may generate for display an option for the user to select a recording setting for the user equipment device. The mobile device may cause the user equipment device to be programmed based on a user selection of the displayed option.

In some implementations, the mobile device may determine the user is attending the live event by retrieving location information from a memory or an external source. The mobile device may retrieve the location information from any combination of coordinates received from GPS circuitry, triangulation, status information received from a social network, manual input from the user, and/or entries in a calendar associated with the user. In some implementations, the location information may be cross-referenced with a list of venues for live events to identify a venue within a predetermined range of a location of the mobile device. In particular, a venue data structure may be retrieved and fields for venues listed in the data structure may be analyzed to compare a location of various venues with location information of the mobile device. Venues listed in the venue data structure that are within a predetermined range (e.g., less than 5 miles) of the mobile device may be identified.

In some implementations, live event schedule information for the identified venue may be retrieved to identify a live event currently in progress as the live event attended by the user. In particular, the mobile device may compare the current time with times at which live events at the identified venue are scheduled to take place. The live events that are near (e.g., within 30 minutes) of the current time may be identified as possible live events the user is attending. The live event that is closest in time and distance to the current time and location may be identified as the live event being attended by the user. In some implementations, the user may select the live event being attended from a list of the possible live events that the mobile device identifies.

In some implementations, the determination that the user is attending the live event may be made by retrieving, from a social network, status information corresponding to the user or corresponding to members associated with the user. The status information is processed to identify the live event currently in attendance by the user.

In some implementations, the mobile device may identify a video associated with the live event by applying live event identification information (e.g., name, scheduled time and location) to a media asset schedule (locally or remotely). The video may be a live broadcast of the live event or a live broadcast of a video related to the live event (e.g., a game in which a rival team is playing).

In some implementations, the mobile device may determine whether the identified video has previously been scheduled for recording on the user equipment device. In response to determining the video has not been scheduled for recording on the user equipment, the option to select the recording setting may include an option to schedule the video for recording on the user equipment device. In some implementations, the video corresponding to the live event may be a first video and a second video may be identified that is scheduled for transmission to the user equipment device during the scheduled transmission of the first video. In such scenarios, the option to select the recording setting may include an option to schedule the second video for recording in place of the first video.

In some embodiments, a determination is made as to whether the mobile device is within a predetermined range of a venue location of the live event near a scheduled end time of the scheduled transmission of the video corresponding to the live event. In some implementations, the option to select the recording setting is generated on the mobile device in response to determining the mobile device is within the predetermined range of the venue near the scheduled end time (e.g., within 5 minutes of the scheduled end time of the video transmission). In some implementations, the option to select the recording setting may include an option to extend a recording of the video on the user equipment device. In some implementations, a recording of the video on another user equipment device associated with a different user is automatically extended in response to determining the mobile device is within the predetermined range of a venue location near the scheduled end time of the live event.

In some embodiments, a determination is made as to whether a predetermined number of other mobile devices are within a predetermined range of a venue location of the live event near a scheduled end time of the scheduled transmission. In some implementations, a number is computed that represents how many of the other mobile devices are within the predetermined range near a scheduled start time of the scheduled transmission, such that the predetermined number of other mobile devices that are determined to be within a predetermined range of a venue near the scheduled end time is greater than half of the computed number. In some implementations, the option to select the recording setting is generated for display on the mobile device in response to determining that the predetermined number of other mobile devices are within the predetermined range near the scheduled end time. In such scenarios, the option to select the recording setting may include an option to extend a recording of the video on the user equipment device.

As referred to above and below, the phrase “live event” should be understood to mean a real-life production happening in real-time (not pre-recorded) with real-life person(s) that takes place at a venue. The live event may include theater, music, dance, opera, concert, and/or sporting event (e.g., football, baseball, etc.) and may use production equipment and services, such as staging, scenery, mechanicals, sound, lighting, video, special effects, transport, packaging, communications, and/or costume and makeup.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with an embodiment of the invention;

FIG. 3 shows an illustrative user equipment device in accordance with another embodiment of the invention;

FIG. 4 is a diagram of an illustrative cross-platform interactive media system in accordance with another embodiment of the invention;

FIG. 5 shows an illustrative display screen that may be used to indicate a live event a user is currently attending in accordance with an embodiment of the invention;

FIG. 6 shows an illustrative venue data structure that may be used to identify a venue and/or live event in accordance with an embodiment of the invention;

FIGS. 7-10 shows an illustrative display screen that may be used to change a recording setting in accordance with an embodiment of the invention; and

FIGS. 11 and 12 show illustrative flow diagrams for remotely managing recording settings based on a geographical location of a user in accordance with an embodiment of the invention.

### DETAILED DESCRIPTION

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application, video guidance application, or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content. As referred to herein, the term “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. The various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

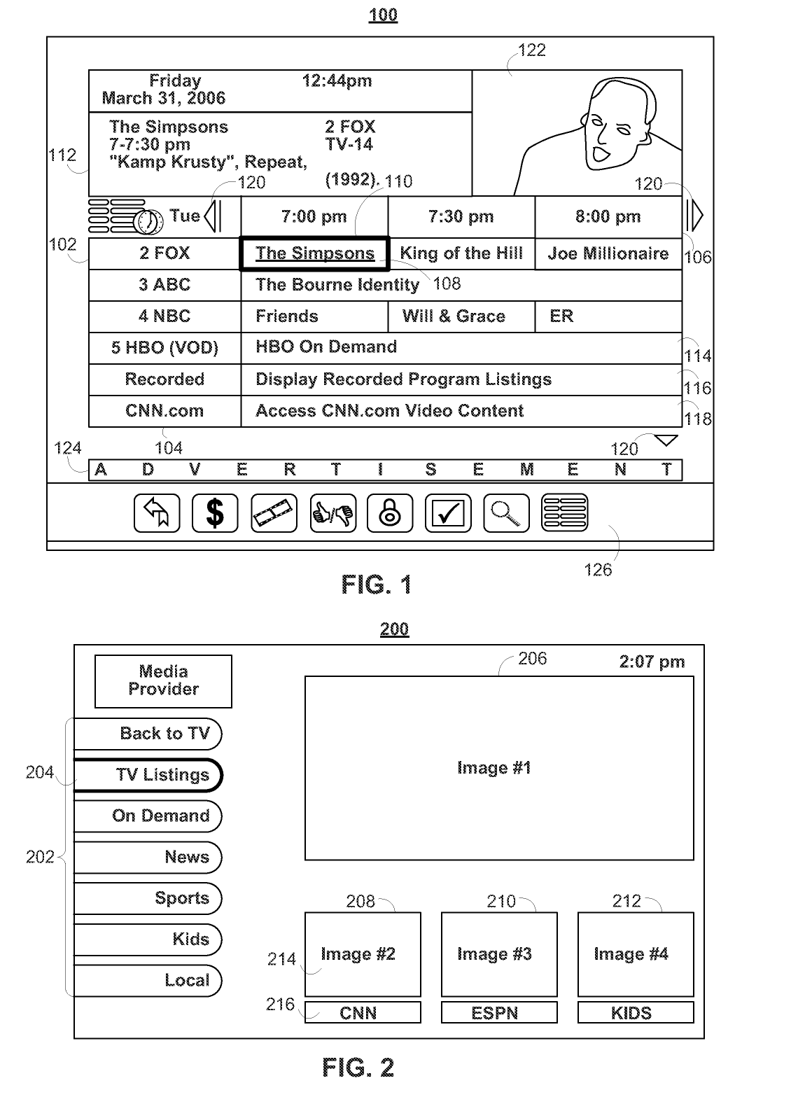

FIGS. 1-2 show illustrative display screens that may be used to provide media guidance data. The display screens shown in FIGS. 1-2 and 7-10 may be implemented on any suitable user equipment device or platform. While the displays of FIGS. 1-2 and 7-10 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

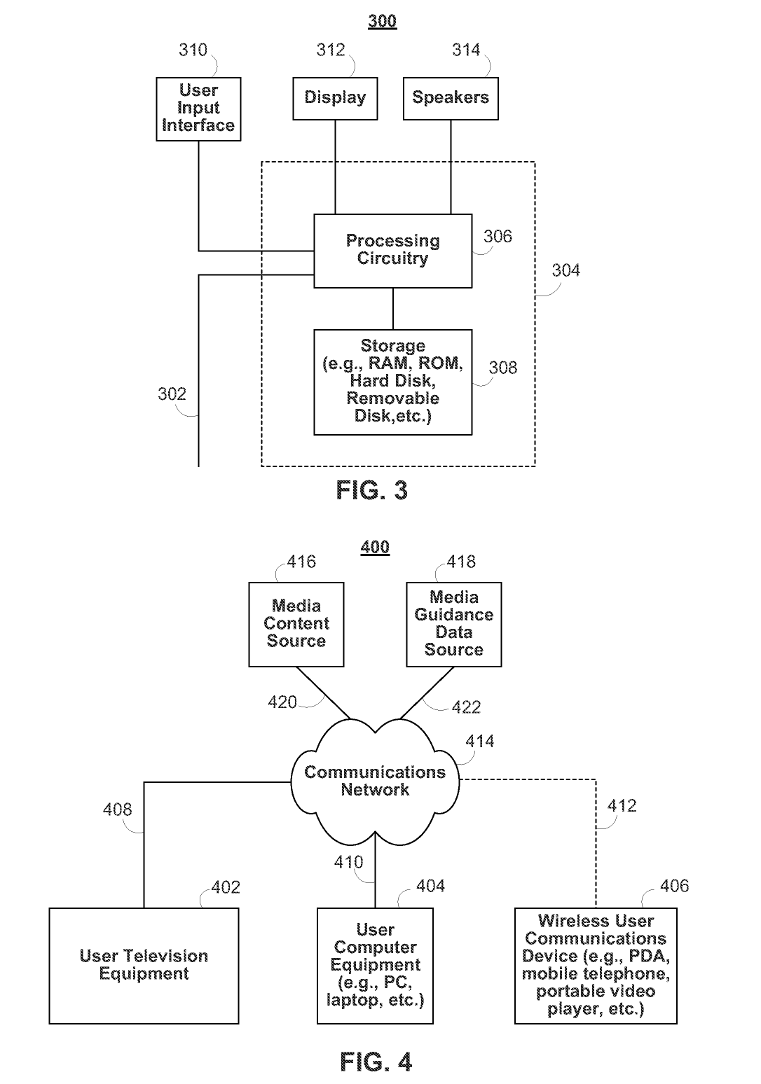

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308).

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

Control circuitry 304 may include position information circuitry, such as Global Positioning System (GPS) circuitry, location-based services (LPS) circuitry, triangulation circuitry, hybrid positioning systems circuitry, or any other suitable position obtaining circuits or combinations of such circuits. Control circuitry 304 may use the position information obtained from the position information circuitry to determine the current position of user equipment device 300. In some implementations, control circuitry 304 may obtain the current position of user equipment device 300 by accessing a social network, such as over the Internet. For example, control circuitry 304 may monitor a status update posted to the social network for the user. Control circuitry 304 may parse the status update for information that identifies a current location of the user (e.g., name of a venue or event the user is attending). In some implementations, control circuitry 304 may monitor a status update of a friend of the user on the social network. In particular, control circuitry 304 may parse the status update of the friend of the user for information that identifies a particular location or event and the name of the user. In some implementations, control circuitry 304 may obtain the current position of user equipment device 300 by accessing a calendar associated with the user. For example, control circuitry 304 may identify a meeting or event listed in the calendar of the user at or near the current time that pertains to a live event or venue.

In some implementations, control circuitry 304 may cross-reference the position of user equipment device 300 with venue location information obtained from a venue data structure. For example, control circuitry 304 may compare the current position of user equipment device 300 with locations of venues within a predetermined range of the current position. The predetermined range may be manually entered by the user through a displayed interface or may be preconfigured. The predetermined range may be a default or user specified value such as three miles. The predetermined range may differ based on the geographic density of the geographic region of the user's position (e.g., a city) and may be set to be a value that represents the shortest distance between two or more venues at the geographic region (e.g., the city). In response to identifying a venue that is closest in proximity to the location of user equipment device 300, control circuitry 304 may retrieve a live events list that includes live events scheduled to take place at the identified venue. Control circuitry 304 may retrieve from the live events list the live event that is scheduled to take place near the current time. Control circuitry 304 may cross-reference the retrieved live event with media schedule information to identify a video, corresponding to the retrieved live event, scheduled for transmission to another user equipment device 300 associated with the user.

In some embodiments, control circuitry 304 of user equipment device 300 may transmit the position of user equipment device 300 to a remote server. In such scenarios, the remote server may cross-reference the position of user equipment device 300 with venues that are within a predetermined range of the position to identify a live event in a similar manner as control circuitry 304 discussed above. The remote server may use the identified live event to identify a video corresponding to the live event that is scheduled for transmission to another user equipment device 300 associated with the user. The remote server may transmit a communication to control circuitry 304 of user equipment device 300 identifying the video corresponding to the live event.

In some embodiments, control circuitry 304 may be housed in a mobile device of the user. Control circuitry 304 may communicate with another user equipment device associated with the user that may be located in another location (e.g., the user's home). For simplicity, this user equipment device in the user's home will be referred to as the “other user equipment device”. Control circuitry 304 may transmit to the other user equipment device requesting a list of all pending scheduled recordings and/or a list of all pending scheduled recordings during a given time period (e.g., scheduled for recording the day the user is attending the live event). Control circuitry 304 may compare videos in the received list with the identified video of the live event to determine whether the video of the live event is scheduled for recording on the other user equipment device.

In some embodiments, in response to determining that the identified video of the live event is not scheduled for recording on the other user equipment device, control circuitry 304 may generate for display a recording setting option on the mobile device. The generated display may include a message indicating to the user that the identified video of the live event is not scheduled for recording. The recording setting option may include one or more interactive options allowing the user to input an instruction to schedule the video of the live event for recording on the other user equipment device. The recording setting option may also include a visual indication of a potential conflict with another scheduled recording should the user select the option to schedule the video of the live event for recording.

In some embodiments, in response to determining that the identified video of the live event is scheduled for recording on the other user equipment device, control circuitry 304 may generate for display a recording setting option on the mobile device. The generated display may include a message indicating to the user that the identified video of the live event is scheduled for recording. The recording setting option may include one or more interactive options allowing the user to input an instruction to un-schedule the recording of the video of the live event, keep the recording scheduled, and/or to schedule an alternate replacement video for recording.

In some embodiments, control circuitry 304 may compare the current time with the scheduled start and end times of the video of the live event scheduled for transmission to the other user equipment device. In some implementations, the recording setting options generated for display on the mobile device may be generated in response to determining the current time is near the scheduled start or end time of the video of the live event. For example, in response to determining the video of the live event is scheduled to start transmission to the other user equipment device in five minutes, control circuitry 304 may generate for display on the mobile device the recording setting to allow the user to schedule the video for recording or un-schedule the video for recording (e.g., to prevent a conflict).

In some implementations, the recording setting options generated for display on the mobile device may include an option to extend the recording of the video of the live event. For example, in response to determining the video of the live event is scheduled to end transmission to the other user equipment device in five minutes and in response to determining the user is still within a predetermined range of the venue of the live event, control circuitry 304 may generate for display on the mobile device the recording setting to allow the user to extend the scheduled recording of the video by an automatically determined or user specified amount, such as 30 minutes.

In some embodiments, a remote server may automatically extend a scheduled recording of the video of the live event for any user equipment device that is recording the video. In particular, the remote server may compute a number of users attending the live event at or near the scheduled start time of the video transmission. At or near the scheduled end time of the video transmission (e.g., five minutes before the scheduled end time), the remote server may compare the total number of users still in attendance at the live event and compare that number to the initial number of users who were at the live event at or near the scheduled start time. In response to determining that the number of users still in attendance at or near the scheduled end time is greater than a predetermined percentage (e.g., greater than 50 percent) of the initial number of users, the remote server may transmit an instruction to all user equipment devices that are recording the video of the live event to extend the recording. In such circumstances, the remote server may also instruct media guidance data source 418 (FIG. 4) to update the media schedule information corresponding to the video of the live event with the extension information. In response to determining that the number of users still in attendance at or near the scheduled end time is equal to or less than the predetermined percentage of the initial number of users, the remote server may determine that it is not necessary to transmit an instruction to all user equipment devices that are recording the video of the live event to extend the recording.

In some implementations, control circuitry 304 may continuously (or periodically) monitor the location of the user while the video of the live event is being recorded on the other user equipment device. In response to determining that the user is outside of the predetermined range of the venue of the live event at a point between the scheduled start and end times (e.g., in the middle), control circuitry 304 may generate for display on the mobile device the recording setting to allow the user to un-schedule the recording of the video. This situation may arise when the user leaves the live event before the live event ends (e.g., because the user loses interest in the live event) and may therefore desire to no longer record the video of the live event. In such circumstances, responsive to receiving a user selection of the option to un-schedule the recording of the video, the mobile device may transmit an instruction to the other user equipment device to stop recording the video and delete any portions of the video that have already been recorded.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, schedule program recordings, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. Similarly, if a user selects a given program for recording on their in-home device using their wireless device at their office, the given program would be scheduled for recording on the user's in-home devices (e.g., user television equipment and user computer equipment). Systems and methods for managing settings across devices and remotely adjusting settings user equipment device using a mobile device are described in greater detail in Ellis et al. U.S. Pat. No. 8,006,263, issued Aug. 23, 2011, which is incorporated by reference herein in its entirety. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the ABC, INC., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels. Media guidance data source 418 may provide venue information, such as a venue data structure. The media guidance data may include a venue data structure which may include information identifying venue names, respective locations, and live event information that take place at the respective venues, such as times and titles of the live events and/or identifiers of corresponding video (media) transmissions of the live events. The venue data structure may enable control circuitry 304 to identify a media selection in the media guidance data (or media schedule information) corresponding to a live event attended by a user.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network.

User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications or the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or, a user device can download content from multiple cloud resources for more efficient downloading. In some embodiments, user equipment devices can use cloud resources for processing operations such as the processing operations performed by processing circuitry described in relation to FIG. 3.

For illustrative purposes, the present invention is described in the context of a live event that is a live football game in a football stadium venue. As referred to above and below, the “live event” is the real-life event taking place at the venue which the user is attending. The handheld device located with the user attending the football game is referred to as the “mobile device” and the device, associated with the user, for which a recording setting is changed, is in a different location (e.g., the user's home) and is referred to as the “other user equipment device.” However, it should be understood that the above and below teachings are equally applicable to any other live event and with other types of devices.

In some embodiments, control circuitry 304 may present recording options settings to a user attending a live event based on the user's geographical location. In particular, control circuitry 304 of the mobile device may determine possible venues hosting live events which the user may be attending. Control circuitry 304 may allow the user to select a venue the user is attending and identify, based on the selected venue, a video corresponding to a live event taking place at the selected venue. Control circuitry 304 may present options for the user allowing the user to schedule a recording of the video, un-schedule a previously scheduled recording of the video, modify or extend a scheduled recording of the video, etc.

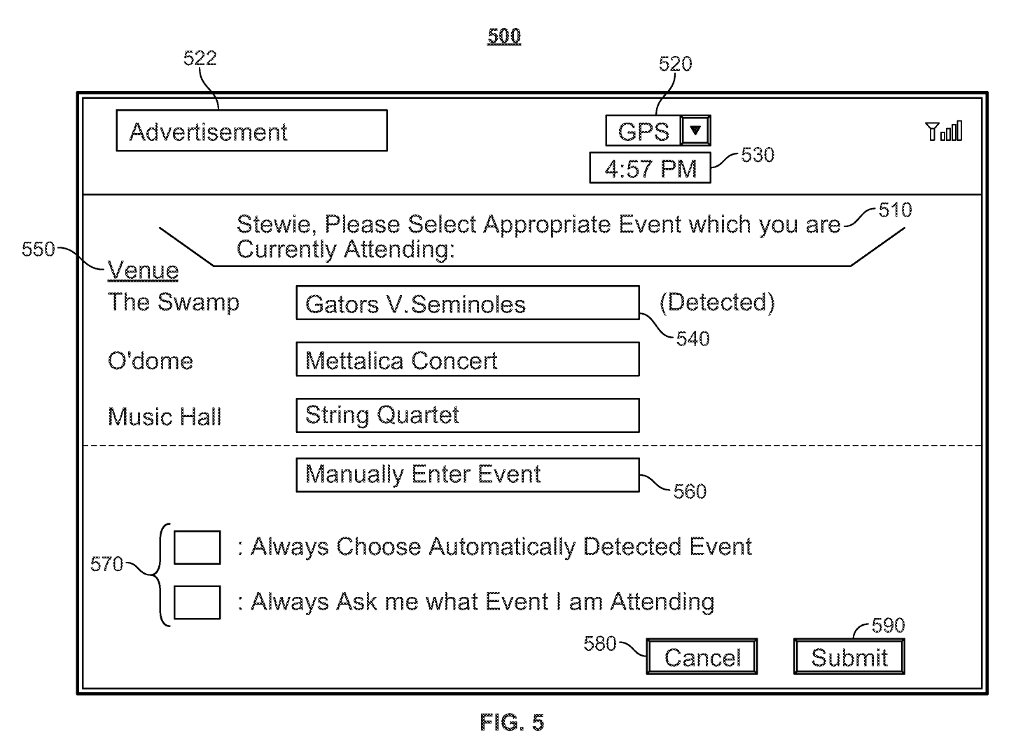

FIG. 5 shows an illustrative display screen 500 that may be used to indicate a live event a user is currently attending in accordance with an embodiment of the invention. Display screen 500 may be generated for display on the mobile device automatically or responsive to a request from the user. In some implementations, control circuitry 304 may generate screen 500 for display on the mobile device in response to detecting that the user is within a predetermined range of a venue. In some embodiments, the detection may be performed automatically at one or more preset times. In some implementations, the user may be attending a live event and may request the mobile device to identify the venue and live event which the user is attending.

In some embodiments, control circuitry 304 may only display screen 500 when control circuitry 304 cannot discern with greater than 50 percent likelihood or probability that the user is at a particular venue.

In particular, control circuitry 304 may identify several possible venues within the predetermined range of the mobile device and may require user input to identify the correct venue which the user is attending. In such circumstances, control circuitry 304 may display screen 500 allowing the user to specify the venue being attended. Screen 500 may be omitted when control circuitry 304 is able to identify the correct venue being attended by the user. In some implementations, when control circuitry 304 identifies multiple venues which the user is possibly attending, control circuitry 304 may cross-reference the current time with live event times scheduled to take place at each venue. In response to identifying only one of the venues as having a live event currently scheduled to take place, control circuitry 304 may determine the only one of the venues as the venue being attended by the user.

In some embodiments, screen 500 may include options region 570. Options region 570 may include a selectable option that when selected by the user instructs control circuitry 304 to configure mobile device to always automatically choose the detected venue and corresponding live event as the event currently being attended by the user. Similarly, options region 570 may include a selectable option that when selected by the user instructs control circuitry 304 to configure mobile device to always request user input when determining the venue and/or live event currently being attended by the user.

In some embodiments, screen 500 may include a location circuitry selection menu 520. Menu 520 may include a list of all possible methods which control circuitry 304 may use to determine the location and/or live event being attended by the user. The user may select one or all methods listed in menu 520. In some implementations, when multiple methods to determine the location and/or live event the user is attending are selected, control circuitry 304 may determine the live event or location of the user based on whether the same live event or location is identified by more than one of the methods. For example, when three methods are chosen to perform the location and event determination and two of the methods identify a first location and event and the other method identifies a different second location and event, control circuitry 304 may determine the actual location and event being attended by the user as being the first location and event. In some implementations, in deciding whether the user is attending one live event or another where both are possibilities, control circuitry 304 may automatically determine the user is attending one rather than the other by analyzing a user profile. For example, when one event is a football game and the other event is a musical concert, control circuitry 304 may determine the user is at the football game instead of the concert when the profile indicates the user has a dislike for classical music and always watches football games (especially the football games taking place at the venue identified by control circuitry 304).

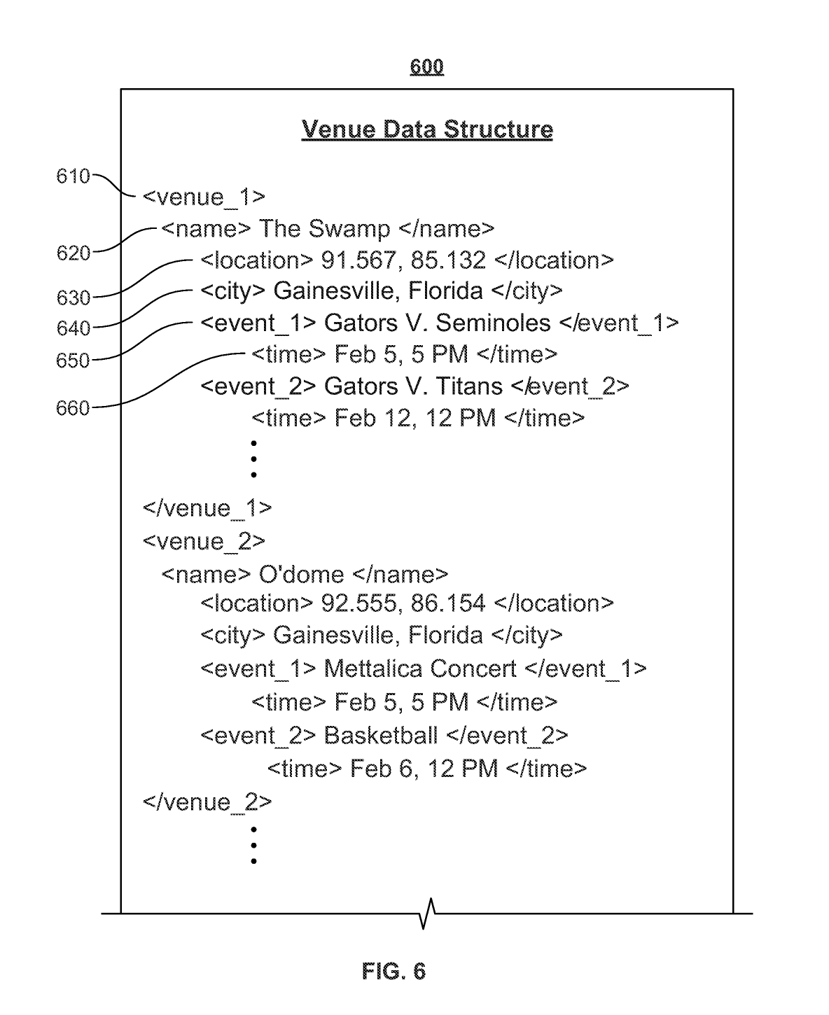

In some implementations, menu 520 may include a GPS option. GPS option, when selected by the user, instructs control circuitry 304 to access GPS circuitry to retrieve GPS information to identify the location of the user. In such circumstances, control circuitry 304 may retrieve a venue data structure 600 (FIG. 6) from a storage device of the mobile device or from an external remote source (e.g., a website on the Internet). Control circuitry 304 may analyze location fields 630 corresponding to each venue field 610. In particular, control circuitry 304 may search through location fields 630 for GPS information that is within a predetermined range (e.g., five miles) of the location retrieved from the GPS circuitry of the mobile device.

In some implementations, control circuitry 304 may access a locally stored or remotely stored database to retrieve venue data structure 600. For example, control circuitry 304 may communicate to the database the location information retrieved from the GPS circuitry, and the database may return to control circuitry 304 only those venues which are within a predetermined range of the mobile device.

In some implementations, after identifying one or more venues that are within the predetermined range of the mobile device, control circuitry 304 may compare the current time, identified in the current time indicator 530, with the time fields 660 that indicate when particular live events listed in event fields 650 are scheduled to take place (or begin) at the corresponding venue identified by venue field 610. Control circuitry 304 may identify the live events listed in fields 650 for which the corresponding time listed in time field 660 is near (within five minutes or 30 minutes) the current time. In some implementations, control circuitry 304 may automatically select one of these live events identified in fields 650 as the live event currently being attended by the user based on one or more factors, such as the user profile, similarity in live event determined using another location determination method selected with menu 520, etc.

In some implementations, control circuitry 304 may generate screen 500 for display on the mobile device with a selectable list of the live events in fields 650 for which the corresponding time listed in time field 660 is near (within five minutes or 30 minutes) the current time. For example, screen 500 may include a live event selection region 550. Live event selection region 550 may include a selectable list of the possible live events. Each selectable listing in the list may include a venue indicator with the name of the venue retrieved from name field 620 in the venue data structure and the corresponding live event name retrieved from event field 650 for which the corresponding time listed in time field 660 is near the current time. Control circuitry 304 may receive user input to move a highlight region 540 to select the live event being attended by the user.

In some embodiments, control circuitry 304 may generate and display screen 500 on the mobile device in response to receiving a user input indicating that the user arrived at a venue. For example, control circuitry 304 may determine the location of the user by receiving a user input selecting a given location from multiple available locations. This may be performed using an application, such as Foursquare. In such an application, the user checks in to a location by selecting from a plurality of nearby locations. Control circuitry 304 may store the selected location and generate screen 500 for display on the mobile device listing possible live events that are taking place at the selected location. Control circuitry 304 may include a link to the application (e.g., Foursquare) as part of menu 520 and/or may list possible nearby venues as part of menu 520 for the user to select where the user is located.

In some implementations, when none of the live events listed in region 550 correspond to the live event being attended by the user, a manual entry region 560 may be used to specify criteria of the live event being attended by the user. Control circuitry 304 may receive input from the user identifying any one, or all, of the following using region 560: the name of the live event, venue name, venue location, scheduled start time, scheduled end time, category, or type.

In some implementations, menu 520 may include a manual entry option. The manual entry option allows the user to input the city and/or state and/or region where the user is located and instructs control circuitry 304 to use that user supplied information to determine the live event being attended by the user. In such circumstances, control circuitry 304 may retrieve venue data structure 600. Control circuitry 304 may analyze the city fields 640 corresponding to each venue field 610. In particular, control circuitry 304 may search through city fields 640 for city, state and/or a region that is within a predetermined range (e.g., five miles) of the location specified by the user.

In some implementations, control circuitry 304 may access a locally stored or remotely stored database to retrieve venue data structure 600. For example, control circuitry 304 may communicate to the database the user supplied location information, and the database may return to control circuitry 304 only those venues which are within a predetermined range of the mobile device.

In some implementations, after identifying one or more venues that are within the predetermined range of the mobile device, control circuitry 304 may compare the current time, identified in the current time indicator 530, with the time fields 660 that indicate when particular live events listed in event fields 650 are scheduled to take place (or begin) at the corresponding venue identified by venue field 610. Control circuitry 304 may identify the live events listed in fields 650 for which the corresponding time listed in time field 660 is near (within five minutes or 30 minutes) the current time. In some implementations, control circuitry 304 may automatically select one of these live events identified in fields 650 as the live event currently being attended by the user based on one or more factors, such as the user profile, similarity in live event determined by using another location determination method selected with menu 520, etc.

In some implementations, menu 520 may include a social network option. The social network option, when selected by the user, instructs control circuitry 304 to search status updates posted by the user or friends of the user (other users associated with the user on the social network) on the social network (e.g., Facebook, Twitter, Myspace, etc.) to identify the live event and/or venue being attended by the user. The social network option may allow the user to specify any number of social networks. Control circuitry 304 may search multiple social networks for status information when more than one is supplied by the user. For example, control circuitry 304 may access, over the Internet, a given social network. By making certain application programming interface (API) function calls provided by the API associated with the given social network, control circuitry 304 may retrieve status information for the user or friends of the user for a particular time period (e.g., the same day or one or more previous days). Control circuitry 304 may parse through the status information to identify venue information (e.g., venue names) and/or live event information (e.g., live event names). When a particular venue or live event is found in the status information, control circuitry 304 may apply a context algorithm to determine whether the venue or live event being mentioned is being mentioned because of current or future activity of the user or friend of the user or for some other reason. In response to determining that the venue or live event is mentioned in context of attending the live event or venue, control circuitry 304 may determine the live event or venue as being currently attended by the user. As previously discussed in connection with the GPS option, control circuitry 304 may automatically select that as the venue or live event being attended by the user or may include the identified venue or live event as part of region 550 to allow the user to select or confirm the venue or live event being attended.

In some implementations, menu 520 may include a calendar option. The calendar option, when selected by the user, instructs control circuitry 304 to search a calendar associated with the user to determine whether the user has previously set a reminder or scheduled an appointment to attend a venue or live event at or near the current time. In response to identifying a reminder or appointment for the current time, control circuitry 304 may retrieve the identified event or venue and may automatically select that as the venue or live event being currently attended by the user or may include the identified venue or live event as part of region 550 to allow the user to select or confirm the venue or live event being attended.

In some embodiments, control circuitry 304 may display a message or prompt 510 in screen 500 requesting the user to specify or confirm which live event the user is currently attending. Control circuitry 304 may display an advertisement 522 in screen 500. Advertisement 522 may include the same or similar functionality as advertisement 124 (FIG. 1). In some implementations, advertisement 522 may be selected based on the live events listed in region 550. In particular, advertisement 522 may be related in subject matter or content to any one of the live events listed in region 550.

In response to receiving a user selection of cancel option 580, control circuitry 304 may remove screen 500 from display, disregard any selections made by the user in screen 500 and may return to a previously displayed screen. In response to receiving a user selection of submit option 590, control circuitry 304 stores the settings input by the user and selections made by the user in the storage device of the mobile device or on a remote server. Control circuitry 304 may proceed to identify a video, corresponding to the live event, scheduled for transmission to the other user equipment device in response to receiving the user selection of submit option 590 based on the automatically detected or user specified live event listed in region 550. When screen 500 is omitted and the mobile device is configured to automatically select the venue and live event the user is currently attending, control circuitry 304 may automatically proceed to search and identify a video, corresponding to the live event, scheduled for transmission to the other user equipment device, without receiving further user input (e.g., without receiving the user selection of option 590).

In some embodiments, after the live event the user is attending is determined, control circuitry 304 may search a media asset schedule to identify a video corresponding to the live event. The video corresponding to the live event may be a live broadcast of the live event being filmed at the venue of the event and transmitted (broadcast) to the other user equipment device in real time from a distribution facility (e.g., a cable or satellite provider). The video corresponding to the live event may be a time delayed (e.g., 10 second delayed) recording of the live event being transmitted to the other user equipment device from a distribution facility. The video corresponding to the live event may be a media asset related in subject matter to the live event. For example, when the live event is a first football game between two teams (e.g., team Gators and team Seminoles), the video may be a live broadcast of a second related football game (e.g., between team Bulldogs and team Hurricanes), happening at about the same time as the first football game, where one or both teams in the second football game is (are) a rival (e.g., Bulldogs) of one of the teams (e.g., Gators) in the first football game.

In some implementations, control circuitry 304 may retrieve from memory of the mobile device a media asset schedule. The media asset schedule may correspond to the schedule of content/media assets being transmitted (broadcast) to the other user equipment device. For example, when the other user equipment device is subscribed to receive service from a first service provider, control circuitry 304 may retrieve from the first service provider the schedule of media asset being transmitted to the other user equipment device. Control circuitry 304 may search the media asset schedule for a video scheduled for transmission to the other user equipment device that corresponds to the live event. Control circuitry 304 may search the media asset schedule by time, title, channel, transmission source, venue name, detailed description or any combination of the same to locate the video corresponding to the live event. In some implementations, instead of or in addition to searching the media asset schedule stored in the memory of the mobile device, control circuitry 304 may transmit a communication to a remote source identifying the live event being attended by the user. The remote source may execute and perform the search for a corresponding video of the live event. The remote source may transmit a communication back to control circuitry 304 identifying the video corresponding to the live event by video ID, title, time, transmission source, or any combination of the same. In some implementations, venue data structure 600 (FIG. 6) may include a corresponding video ID field (not shown) for one or more events listed for a venue. Video ID field may be retrieved by control circuitry 304 and used to identify the video corresponding to the live event in the media asset schedule. The video ID may map one-to-one with the video listed in the media asset schedule.

Once the corresponding video is identified, control circuitry 304 may store an identifier in memory for the video that cross-references the video with the live event. The identifier may be generated based on information stored in the media asset schedule for the video, such as the scheduled start and end times, transmission source, title, detailed description, etc. The identifier may include the scheduled start time and the scheduled end time of the video transmission corresponding to the live event. When no video is identified in the media asset schedule, control circuitry 304 may generate an alert for display on the mobile device. The alert may indicate to the user that no video is available for access on the other user equipment device. In response to identifying the video corresponding to the live event, control circuitry 304 may transmit an access communication to the other user equipment device. The access communication may request the other user equipment device to determine whether the video has been scheduled for recording on a video recording device of the other user equipment. For example, the access communication may include the identifier of the video along with a command to look at the memory of scheduled recordings to determine whether the video is scheduled for recording. The access communication may be transmitted directly to the other user equipment from the mobile device. Alternatively, the access communication may be transmitted to a remote source (server) requesting the remote source to communicate with the other user equipment device to make the determination of whether the video has been scheduled for recording.

In some embodiments, control circuitry 304 may transmit a communication to the other user equipment device requesting a list of pending scheduled recordings from the other user equipment device. Control circuitry 304 may analyze the list received from the other user equipment device to determine whether the video has been scheduled for recording on the other user equipment device. In some implementations, when control circuitry 304 determines that the video is not scheduled for recording on the other user equipment device, control circuitry 304 may generate for display on the mobile device a message and/or recording settings adjustment options.

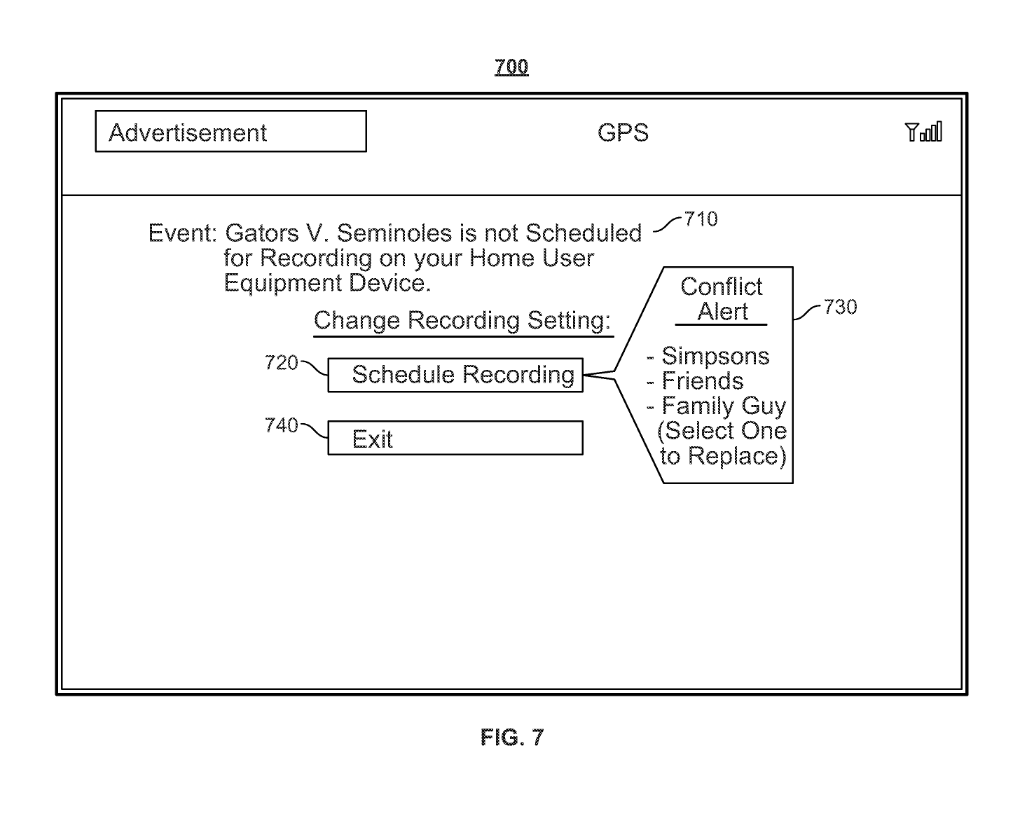

FIG. 7 shows an illustrative display screen 700 that may be used to change a recording setting in accordance with an embodiment of the invention. Screen 700 may include a message region 710 and recording settings adjustment option 720. Control circuitry 304 may generate for display on the mobile device screen 700 in response to determining that a video of the live event being attended by the user is not scheduled for recording. Screen 700 may be displayed in response to detecting that the user is located at the venue of the live event near the scheduled start time of the event (determined based on the media asset schedule) (e.g., five minutes before the scheduled start time) and has not previously scheduled a video corresponding to the live event for recording on the other user equipment device.

Screen 700 may be displayed as an overlay (on top of what is currently being displayed on the mobile device screen) without user input and may be accompanied with audible tone(s) and/or vibration(s). The audible tones may alert the user that screen 700 is being presented when the user is not looking at the screen of the mobile device. The audible tone may capture the user's attention and cause the user to look at the screen to receive the message.

Message 710 may inform the user that he/she is attending a live event for which a video corresponding to the event has not been previously scheduled for recording on the other user equipment device. Message 710 may include the name of the live event and the title of the identified video. In some implementations, message 710 may include a graphic, an image and/or short promotional video clip (e.g., five to ten second video clip, such as a highlight of the teams playing in the video) associated with the identified video to assist the user in identifying the video. Message 710 may be interactive such that, when selected by the user, additional information associated with the identified video is displayed (e.g., as a further overlay or in a separate screen).

Recording settings adjustment option 720 may allow the user to schedule a recording of the video corresponding to the live event. In response to receiving a user selection of recording settings adjustment option 720, control circuitry 304 may schedule the identified video for recording on the other user equipment device. Control circuitry 304 may transmit an access communication directly or through a remote source to the other user equipment device. The access communication may include an instruction with an identification of the video corresponding to the live event and a command to schedule the video recorder of the other user equipment device to record the transmission of the corresponding video to the other user equipment device. The identification of the video in the instruction may include any other information stored in the memory of the mobile device that was retrieved from the media asset schedule for the identified video corresponding to the live event.

In some embodiments, control circuitry 304 may automatically perform an action (e.g., for execution on the other user equipment device) for the video corresponding to the live event without displaying screen 700 when the video has not been scheduled for recording on the other user equipment device. For example, in response to identifying the video corresponding to the live event, control circuitry 304 may automatically analyze a user profile to determine what action to perform for the video. In particular, control circuitry 304 may determine whether the user typically performs a particular action on the other user equipment device for video assets corresponding to live events of a given type. As referred to herein the term “action” should be understood to include any media guidance application functionality, such as, scheduling a recording of the video, setting a reminder for the video, transmitting the video to another device, posting a comment related to the video to a social network, and/or any combination of the same. For example, the user profile may indicate that the user always or substantially always schedules for recording football games being broadcast on a given day (e.g., Monday night). As referred to herein, the term “type” for the live events should be understood to include live events associated with a particular category or genre, scheduled to take place at a particular time and/or place, have a content or program characteristic in common, have a participant (e.g., player or team) in common, and/or any combination of the same.

For example, control circuitry 304 may in response to detecting that the user is attending a live event, automatically schedule a recording of a video corresponding to the live event on the other user equipment device. In particular, control circuitry 304 may automatically retrieve a list of scheduled recordings from the other user equipment device and determine whether the video corresponding to the live event is scheduled for recording. In response to determining that the video is not scheduled for recording, control circuitry 304 may automatically schedule the video corresponding to the live event for recording. For example, control circuitry 304 may automatically transmit an identification of the video to the other user equipment device with an instruction to schedule the video for recording. As a result, the other user equipment device may be programmed or program itself to record the video corresponding to the live event.

In some implementations, control circuitry 304 may display a window 730 of potential conflicts adjacent to or anywhere else on screen 700. In some embodiments, control circuitry 304 may display window 730 in response to receiving a user selection of option 720 and before (or after) transmitting the instruction to the other user equipment device to schedule the video for recording. Alternatively, control circuitry 304 may display window 730 initially when instructed to display screen 700.

Window 730 may include one or more media assets that are scheduled for transmission to the other user equipment device between the scheduled start and end times of the video corresponding to the live event.

The media assets in window 730 may be selected for inclusion in window 730 based on a preference profile associated with the user. In particular, the media assets in window 730 may have attributes or characteristics that match the preference profile associated with the user. Window 730 may be used to inform the user of other possible media assets that can be scheduled for recording on the other user equipment device instead of the video corresponding to the live event. One or more media assets in window 730 may have been previously scheduled for recording. Control circuitry 304 may include an indicator with such media assets to inform the user that if the video corresponding to the live event is scheduled for recording, then one of the previously scheduled assets that overlap in transmission time (e.g., are scheduled for transmission between the scheduled start and end times of the video corresponding to the live event) will not be recorded. For example, the other user equipment device may only be able to record one media asset at a time (e.g., because the other user equipment device may have only one tuner or lack resources to perform multiple recordings). Accordingly, if the user selects the option to schedule the video corresponding to the live event for recording, a different media asset will not be recorded.

In some implementations, the user may modify which media assets listed in window 730 a) remain scheduled for recording, b) become un-scheduled from recording, or c) will become scheduled for recording. Control circuitry 304 may communicate the modifications of the recording activity made using window 730 and screen 700 to the other user equipment device (e.g., directly or through the remote source). For example, control circuitry 304 may receive, from the user, a selection or input to unscheduled a previously scheduled media asset from recording in order to enable the video corresponding to the live event (or one of the other media assets in window 730 which have not been scheduled for recording) to be scheduled for recording on the other user equipment device. Similarly, instead of scheduling the video corresponding to the live event for recording, the user may schedule one of the media assets listed in window 730 for recording. In response to receiving the user selections, control circuitry 304 may generate corresponding instructions for transmission to the other user equipment device. The other user equipment device may receive the instructions and modify the schedule of recordings based on the inputs control circuitry 304 received on the mobile device.

In some embodiments, screen 700 may include an exit option 740. In response to receiving a user selection of exit option 740, control circuitry 304 may return the user to the previous screen or activity being performed on the mobile device and remote screen 700 from display. In some embodiments, a video window (not shown) may be included in screen 700 (e.g., on the bottom right corner). The video window may include a video feed of the live event being attended by the user or the content being provided by the content source currently that is scheduled to transmit the video of the live event to the other user equipment device. Video window may alternatively include promotional or advertisement material related to the live event being attended by the user.

In some embodiments, control circuitry 304 may transmit a communication to the other user equipment device from the mobile device requesting a list of pending scheduled recordings from the other user equipment device. Control circuitry 304 may analyze the list received from the other user equipment device to determine whether the video has been scheduled for recording on the other user equipment device. In some implementations, when control circuitry 304 determines that the video is scheduled for recording on the other user equipment device, control circuitry 304 may generate for display on the mobile device a message and/or recording settings adjustment options.

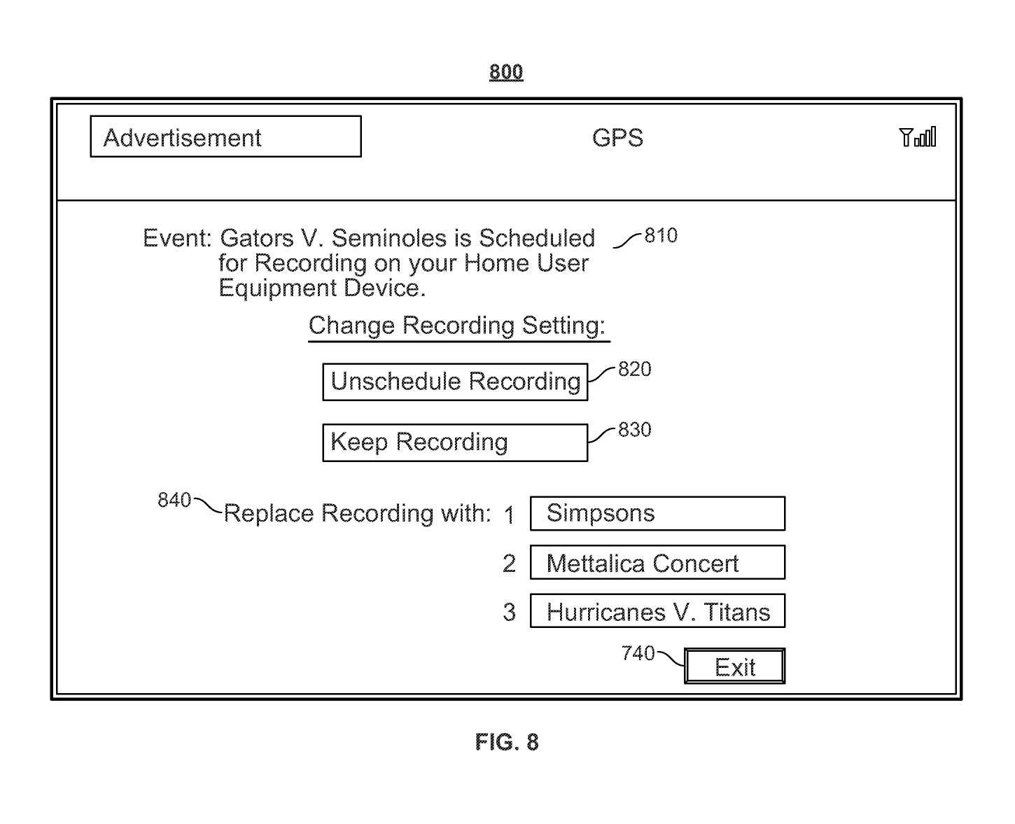

FIG. 8 shows an illustrative display screen 800 that may be used to change a recording setting in accordance with an embodiment of the invention. Screen 800 may include a message region 810 and recording settings adjustment options 820, 840, and 830. Control circuitry 304 may generate for display on the mobile device screen 800 in response to determining that a video of the live event being attended by the user is scheduled for recording. Screen 800 may be displayed in response to detecting that the user is located at the venue of the live event near the scheduled start time of the event (determined based on the media asset schedule) (e.g., five minutes before the scheduled start time) and has previously scheduled a video corresponding to the live event for recording on the other user equipment device.

Screen 800 may be displayed as an overlay (on top of what is currently being displayed on the mobile device screen) without user input and may be accompanied with audible tone(s) and/or vibration(s). The audible tones may alert the user that screen 800 is being presented when the user is not looking at the screen of the mobile device. The audible tone may capture the user's attention and cause the user to look at the screen to receive the message.

Message 810 may inform the user that he/she is attending a live event for which a video corresponding to the event has been previously scheduled for recording on the other user equipment device. Message 810 may include the name of the live event and the title of the identified video. In some implementations, message 810 may include a graphic, an image and/or short promotional video clip (e.g., five to ten second video clip, such as a highlight of the teams playing in the video) associated with the identified video to assist the user in identifying the video. Message 810 may be interactive such that, when selected by the user, additional information associated with the identified video is displayed (e.g., as a further overlay or in a separate screen).

Recording settings adjustment option 820 may allow the user to un-schedule the recording of the video corresponding to the live event. In response to receiving a user selection of recording settings adjustment option 820, control circuitry 304 may un-schedule the identified video from recording on the other user equipment device. Control circuitry 304 may transmit an access communication directly or through a remote source to the other user equipment device. The access communication may include an instruction with an identification of the video corresponding to the live event and a command to remove from the list of scheduled recordings on the video recorder of the other user equipment device, the transmission of the corresponding video to the other user equipment device. The identification of the video in the instruction may include any other information stored in the memory of the mobile device that was retrieved from the media asset schedule for the identified video corresponding to the live event.

Recording setting adjustment option 830 may allow the user to instruct control circuitry 304 to keep the video corresponding to the live event in the list of scheduled recordings. In response to receiving a user selection of option 830, control circuitry 304 may remove screen 800 from display and return the user to the previous activity being performed on the mobile device. Control circuitry 304 may not instruct the other user equipment device to perform any modifications to the recording schedule in response to receiving the user selection of option 830.

In some implementations, control circuitry 304 may display a recording setting adjustment option 840 allowing the user to select a replacement media asset in screen 800. In some embodiments, control circuitry 304 may option 840 in response to receiving a user selection of option 830. Alternatively, control circuitry 304 may display option 840 initially when instructed to display screen 800.

Option 840 may include one or more media assets that are scheduled for transmission to the other user equipment device between the scheduled start and end times of the video corresponding to the live event (e.g., for which the transmission times overlap with the transmission time of the video corresponding to the live event). The media assets for option 840 may be selected for inclusion in screen 800 based on a preference profile associated with the user. In particular, the media assets for option 840 may have attributes or characteristics that match the preference profile associated with the user. Option 840 may be used to inform the user of other possible media assets that can be scheduled for recording on the other user equipment device instead of (or to replace recording of) the video corresponding to the live event.

Control circuitry 304 may communicate the modifications of the recording activity made using screen 800 to the other user equipment device (e.g., directly or through the remote source). For example, control circuitry 304 may receive, from the user, a selection or input to replace the scheduled recording of the video corresponding to the live event with one of the media assets display for option 840 which have not been scheduled for recording. In response to receiving the user selection, control circuitry 304 may generate corresponding instructions for transmission to the other user equipment device to schedule for recording the media asset selected for option 840 and un-schedule from recording the video corresponding to the live event. The other user equipment device may receive the instructions and modify the schedule of recordings based on the inputs control circuitry 304 received on the mobile device.

In some embodiments, control circuitry 304 may automatically perform an action (e.g., for execution on the other user equipment device) for the video corresponding to the live event without displaying screen 800 when the video has been scheduled for recording on the other user equipment device. For example, in response to identifying the video corresponding to the live event, control circuitry 304 may automatically analyze a user profile to determine what action to perform for the video. In particular, control circuitry 304 may determine whether the user typically performs a particular action on the other user equipment device for video assets corresponding to live events of a given type.

For example, control circuitry 304 may in response to detecting that the user is attending a live event, automatically un-schedule a recording of a video corresponding to the live event on the other user equipment device or may schedule an alternate video for recording (e.g., a video of a media asset listed for option 840). In particular, control circuitry 304 may automatically retrieve a list of scheduled recordings from the other user equipment device and determine whether the video corresponding to the live event is scheduled for recording. In response to determining that the video is scheduled for recording, control circuitry 304 may automatically un-schedule the video corresponding to the live event for recording. For example, control circuitry 304 may automatically transmit an identification of the video to the other user equipment device with an instruction to un-schedule the video for recording. As a result, the other user equipment device may be programmed or program itself to remove the video corresponding to the live event from a list of videos scheduled for recording.

In some embodiments, control circuitry 304 may continuously or periodically (e.g., every five minutes), determine the location of the user and compare the determined location with the location of the live event being attended by the user. The location may be determined in any manner discussed above in connection with FIG. 5. Control circuitry 304 may compare the current time with the scheduled end time of the video corresponding to the live event.

Control circuitry 304 may generate for display recording settings adjustment option on the mobile device based on whether the user is within a predetermined range of the venue of the live event near or before the scheduled end time of the video corresponding to the live event.

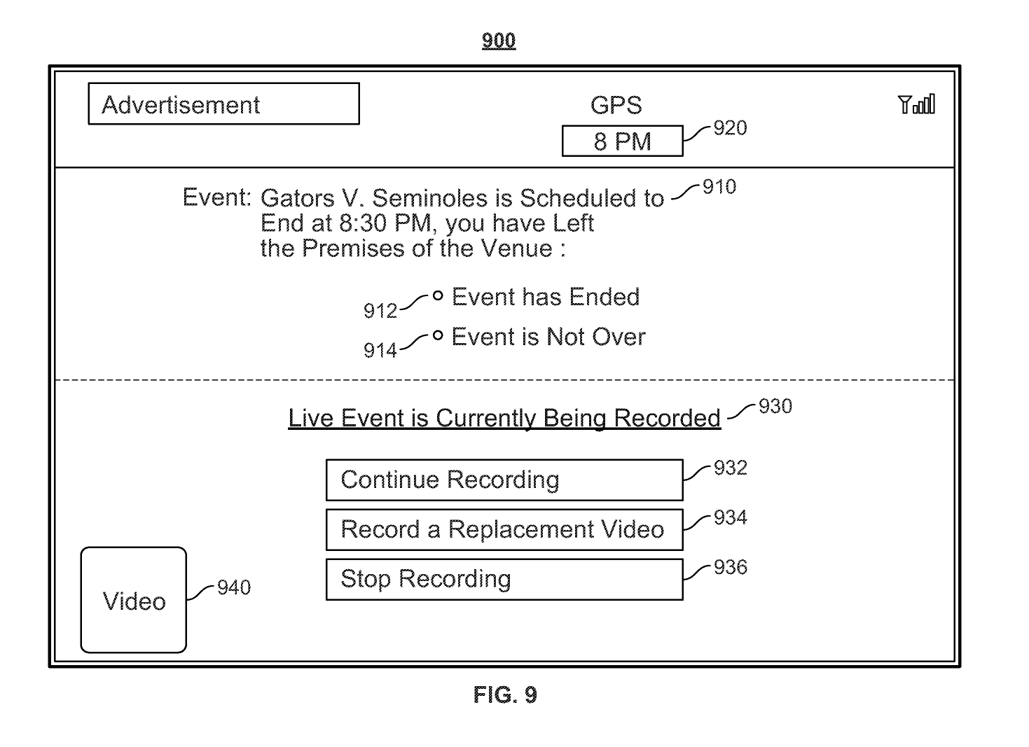

FIG. 9 shows an illustrative display screen 900 that may be used to change a recording setting in accordance with an embodiment of the invention. Screen 900 may include a message region 910 and recording settings adjustment options region 930. Control circuitry 304 may generate for display on the mobile device screen 900 in response to determining that a video of the live event being attended by the user is scheduled for recording and that the user has left the premises (e.g., is outside a predetermined range of the venue of the live event) near or before the scheduled end time of the video.

In some implementations, control circuitry 304 may determine the location of the user and may retrieve the media asset schedule data corresponding to the video of the live event. Control circuitry 304 may compare the scheduled end time from the media asset schedule data with the current time 920. Control circuitry 304 may determine that the location of the user is within a predetermined range (e.g., less than 1 mile) of the venue of the live event and that the current time has not reached (e.g., is before or near) the scheduled end time. In response to this determination, control circuitry 304 may proceed without displaying screen 900.

In some implementations, control circuitry 304 may detect the user has left the premises (e.g., is outside the predetermined range) of the venue of the live event. This determination may be performed in any suitable manner, such as those discussed above in connection with FIG. 5. In response to detecting the user has left the venue premises, control circuitry 304 may compare the scheduled end time from the media asset schedule data with the current time 920. When the current time has not reached (e.g., is before or near) the scheduled end time, control circuitry 304 may generate for display screen 900. Screen 900 may allow the user to input information about the live event, such as whether the live event has ended earlier than the scheduled end time, whether the live event is not yet over (e.g., the user left the live event early), and modify recording settings associated with the video corresponding to the live event when control circuitry 304 determines the video is being recorded or has been scheduled for recording on the other user equipment device.

Screen 900 may be displayed as an overlay (on top of what is currently being displayed on the mobile device screen) without user input and may be accompanied with audible tone(s) and/or vibration(s).

The audible tones may alert the user that screen 900 is being presented when the user is not looking at the screen of the mobile device. The audible tone may capture the user's attention and cause the user to look at the screen to receive the message.

Options 912 and 914 may be presented to the user in screen 900. Options 912 and 914 may allow the user to supply information to instruct control circuitry 304 to update the media asset schedule information for the video corresponding to the live event. For example, in response to receiving a user selection of option 912, control circuitry 304 may determine that the live event has ended earlier than the scheduled end time of the video corresponding to the live event. Based on this determination, control circuitry 304 may transmit a communication to media guidance data source 418 (FIG. 4) identifying the video corresponding to the live event and instructing media guidance data source 418 to update the media asset schedule information for the video with a new scheduled end time (e.g., current time 920 instead of 8:30 PM). In some implementations, media guidance data source 418 may only update the media asset schedule information for the video when a predetermined number of requests (e.g., 50 requests) to update the media asset schedule information for the video are received from different users. The other user equipment device may receive the updated media asset schedule information and may in response end the recording of the video corresponding to the live event before the scheduled end time.

In some embodiments, when media guidance data source 418 updates the media asset schedule information for the video, media guidance data source 418 may transmit the updated information to all user equipment devices associated with other users. As a result, any of the other user equipment devices associated with other users that are recording the video corresponding to the live event, may update the recording schedule to end the recording of the video early (e.g., since the live event ended before the scheduled end time). In some implementations, in response to receiving a user selection of option 912, control circuitry 304 may directly or indirectly (through a remote source) transmit a communication to the other user equipment device instructing the other user equipment device to update the media asset schedule information. In some implementations, in response to receiving a user selection of option 912, control circuitry 304 transmit the instruction to the other user equipment device to update the media asset schedule information only when control circuitry 304 determines that the other user equipment device is scheduled to record the video corresponding to the live event.

Option 914 may allow the user to instruct control circuitry 304 that the live event has not ended even though the user left the premises early (e.g., before the scheduled end time of the video corresponding to the live event). In response to receiving a user selection of option 914, control circuitry 304 may remove screen 900 from display and return the user to the previous activity being performed on the mobile device. Control circuitry 304 may not instruct the other user equipment device to perform any modifications to the recording schedule in response to receiving the user selection of option 914. Control circuitry 304 may not instruct media guidance data source 418 to perform any updates to the media asset schedule in response to receiving the user selection of option 914.

In some embodiments, control circuitry 304 may detect the user has left the premises (e.g., is outside the predetermined range) of the venue of the live event before the scheduled end time of the video corresponding to the live event. In response to this detection, control circuitry 304 may determine whether the user has previously scheduled the video corresponding to the live event for recording on the user equipment device. When control circuitry 304 determines that the video corresponding to the live event has previously been scheduled for recording, control circuitry 304 may generate for display in screen 900, recording settings adjustment options 930. In some implementations, when control circuitry 304 determines that the video corresponding to the live event has not previously been scheduled for recording, control circuitry 304 may omit from screen 900 recording settings adjustment options 930.

Options region 930 may include a continue recording option 932, a record replacement video option 934 and/or a stop recording option 936. In response to receiving a user selection of option 932, control circuitry 304 may remove screen 900 from display and return the user to the previous activity being performed on the mobile device. Control circuitry 304 may not instruct the other user equipment device to perform any modifications to the recording settings for the video corresponding to the live event in response to receiving the user selection of option 932. In response to receiving a user selection of option 936, control circuitry 304 may instruct the other user equipment device to stop or terminate recording of the video corresponding to the live event. The other user equipment device may, in response to receiving the instruction from the mobile device, stop recording the video corresponding to the live event and begin scheduling an alternate media asset (e.g., a media asset that previously could not be recorded because of a conflict in resources for recording on the other user equipment device).

In response to receiving a user selection of option 934, control circuitry 304 may display a list of one or more media assets similar to the display discussed above in connection with option 840 (FIG. 8). Option 934 may include one or more media assets that are scheduled for transmission to the other user equipment device between current time 920 and the scheduled end time of the video corresponding to the live event (e.g., for which the transmission times overlap with the transmission time of the video corresponding to the live event). The media assets for option 934 may be selected for inclusion in screen 900 based on a preference profile associated with the user. In particular, the media assets for option 934 may have attributes or characteristics that match the preference profile associated with the user. Option 934 may be used to inform the user of other possible media assets that can be scheduled for recording on the other user equipment device instead of (or to replace recording of) the video corresponding to the live event.

Control circuitry 304 may communicate the modifications of the recording activity made using screen 900 (e.g., with options region 930) to the other user equipment device (e.g., directly or through the remote source). For example, control circuitry 304 may receive, from the user, a selection or input to replace the scheduled recording of the video corresponding to the live event with one of the media assets displayed for option 934 which have not been scheduled for recording. In response to receiving the user selection, control circuitry 304 may generate corresponding instructions for transmission to the other user equipment device to schedule for recording the media asset selected for option 934 and terminate recording of the video corresponding to the live event. The other user equipment device may receive the instructions and modify the schedule of recordings based on the inputs control circuitry 304 received on the mobile device.

In some embodiments, a video window 940 may be included in screen 900 (e.g., on the bottom right corner). Video window 940 may include a video feed of the live event being attended by the user or the content being provided by the content source that is currently scheduled to transmit the video of the live event to the other user equipment device. Video window 940 may alternatively include promotional or advertisement material related to the live event being attended by the user. In some implementations, video window 940 may display the content currently being accessed, recorded and/or viewed on the other user equipment device. The video feed for video window 940 may be received directly or indirectly (e.g., through a remote source) from the other user equipment device. For example, the other user equipment device may be tuned to a channel broadcasting the video for the live event being attended by the user. The video for this channel may be transmitted to the mobile device and displayed in video window 940. In some implementations, the video for the channel may be displayed in a full screen display on the mobile device.

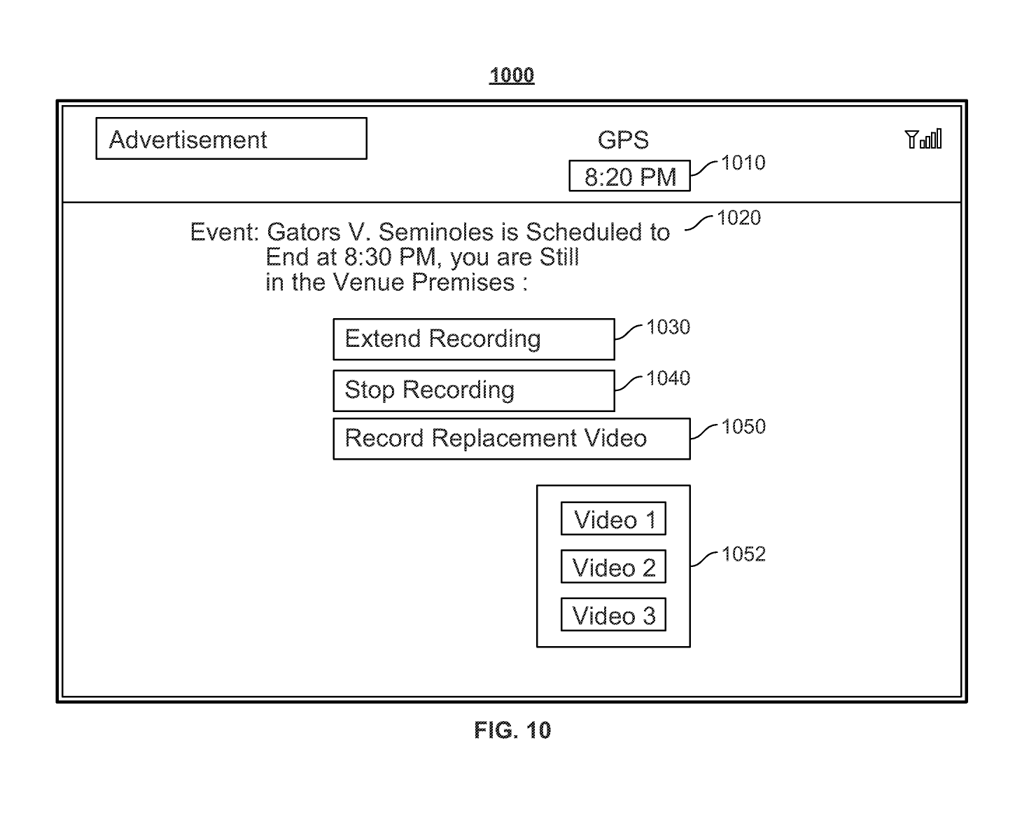

FIG. 10 shows an illustrative display screen 1000 that may be used to change a recording setting in accordance with an embodiment of the invention. Screen 1000 may include a message region 1020 and recording settings adjustment options 1030, 1040 and 1050. Control circuitry 304 may generate for display on the mobile device screen 1000 in response to determining that a video corresponding to the live event being attended by the user is scheduled for recording and that the user is still at the premises (e.g., is within a predetermined range of the venue of the live event) near (e.g., five minutes before) the scheduled end time of the video.

In some implementations, control circuitry 304 may determine the location of the user and may retrieve the media asset schedule data corresponding to the video of the live event. Control circuitry 304 may compare the scheduled end time from the media asset schedule data with the current time 1010. Control circuitry 304 may determine that the location of the user is within a predetermined range (e.g., less than 1 mile) of the venue of the live event and that the current time is near (e.g., within five minutes before) the scheduled end time. In response to this determination, control circuitry 304 may determine whether the video corresponding to the live event is being recorded on the other user equipment device. When the video is being recorded, control circuitry 304 may display screen 1000 on the mobile device. One of the differences between screen 900 and screen 1000 is the determination of whether the user is outside the predetermined range of the venue of the live event (i.e., screen 900) or is within the predetermined range of the live event (i.e., screen 1000) near the scheduled end time of the video corresponding to the live event.

Screen 1000 may be displayed as an overlay (on top of what is currently being displayed on the mobile device screen) without user input and may be accompanied with audible tone(s) and/or vibration(s). The audible tones may alert the user that screen 900 is being presented when the user is not looking at the screen of the mobile device. The audible tone may capture the user's attention and cause the user to look at the screen to receive the message.

Message 1020 may inform the user that the live event he/she is attending has a corresponding video being recorded on the other user equipment device and that the video is scheduled to end at a scheduled end time (e.g., 8:30 PM). Message 1020 may include the name of the live event and the title of the identified video. In some implementations, message 1020 may include a graphic, an image and/or short promotional video clip (e.g., five to ten second video clip, such as a highlight of the teams playing in the video) associated with the identified video to assist the user in identifying the video. Message 1020 may be interactive such that, when selected by the user, additional information associated with the identified video is displayed (e.g., as a further overlay or in a separate screen).

Message 1020 may indicate that control circuitry 304 has determined that the user's location is still within a predetermined range of the venue of the live event and that current time 1010 (e.g., 8:20 PM) is near the scheduled end time (e.g., 8:30 PM). Message 1020 may alert the user of the fact that the media asset schedule information has an end time which is inaccurate (e.g., because the live event is likely to go beyond the scheduled end time, such as because of overtime in the football game). Because the media asset schedule information has an inaccurate scheduled end time, the recording of the video corresponding to the live event on the other user equipment device will be incomplete and will be cut off short. Since the user is at the live event, the user is in a better position to determine whether the live event will end at the scheduled end time (e.g., 8:30 PM) or will go beyond the scheduled end time.

Recording setting adjustment options 1030, 1040 and 1050 may be presented to the user in screen 1000. Options 1030, 1040 and 1050 may allow the user to supply information to instruct control circuitry 304 to update the media asset schedule information for the video corresponding to the live event and modify the recording of the video corresponding to the live event. For example, in response to receiving a user selection of option 1030, control circuitry 304 may determine that the live event will run or extend beyond the scheduled end time of the video corresponding to the live event. Based on this determination, control circuitry 304 may transmit a communication to media guidance data source 418 (FIG. 4) identifying the video corresponding to the live event and instructing media guidance data source 418 to update the media asset schedule information for the video with a new scheduled end time (e.g., 9 PM instead of 8:30 PM). In some implementations, media guidance data source 418 may only update the media asset schedule information for the video when a predetermined number of requests (e.g., 50 requests) to update the media asset schedule information for the video is received from different users. The other user equipment device may receive the updated media asset schedule information and may in response extend the recording of the video corresponding to the live event.

In some implementations, in response to receiving a user selection of option 1030, a set of extension options may be presented (not shown). The set of extension options may include a list of extension times in increments of 15 minutes. For example, one extension option may allow the user to specify a 15-minute extension, while another may allow the user to specify a 30-minute extension. The list may also include a recommended extension time that may be automatically predicted. In response to receiving a user selection of one of the extension options, control circuitry 304 of the mobile device may transmit an instruction to the other user equipment device to extend the recording of the video corresponding to the live event by the amount of time specified using the extension options. In some embodiments, instead of presenting the extension options, control circuitry 304 may by default always extend the recording of the video on the other user equipment device by 30 minutes or some other predetermined amount of time.

In some embodiments, when media guidance data source 418 updates the media asset schedule information for the video, media guidance data source 418 may transmit the updated information to all user equipment devices associated with other users. As a result, any of the other user equipment devices associated with other users that are recording the video corresponding to the live event, may update the recording schedule to extend the recording of the video (e.g., since the live event will end after the scheduled end time). In some implementations, in response to receiving a user selection of option 1030, control circuitry 304 may directly or indirectly (through a remote source) transmit a communication to the other user equipment device instructing the other user equipment device to update the media asset schedule information with a new scheduled end time.

In some embodiments, screen 1000 may be presented even though the other user equipment device is not scheduled to record a video corresponding to the live event. In such scenarios, the user may select option 1030 to update the scheduled end time stored in the media schedule information. Accordingly, other users that are recording the video corresponding to the live event on respective user equipment devices may receive the updated new scheduled end time and may thereby extend recording of the video.

In response to receiving a user selection of option 1040, control circuitry 304 may remove screen 900 from display and return the user to the previous activity being performed on the mobile device. Control circuitry 304 may not instruct the other user equipment device to perform any modifications to the recording schedule in response to receiving the user selection of option 1040. Control circuitry 304 may not instruct media guidance data source 418 to perform any updates to the media asset schedule in response to receiving the user selection of option 1040. As a result of receiving the user selection of option 1040, the other user equipment device will end or terminate recording of the video corresponding to the live event at the scheduled end time.

In response to receiving a user selection of option 1050, control circuitry 304 may display a list 1052 of one or more media assets similar to the display discussed above in connection with option 840 (FIG. 8) and option 934 (FIG. 9). Option 1050 may include one or more media assets that are scheduled for transmission to the other user equipment device between current time 1010 and the scheduled end time of the video corresponding to the live event (e.g., for which the transmission times overlap with the transmission time of the video corresponding to the live event).

The media assets for option 1050 may be selected for inclusion in screen 1000 based on a preference profile associated with the user. In particular, the media assets in list 1052 may have attributes or characteristics that match the preference profile associated with the user. Option 1050 and list 1052 may be used to inform the user of other possible media assets that can be scheduled for recording on the other user equipment device instead of (or to replace recording of) the video corresponding to the live event.

Control circuitry 304 may communicate the modifications of the recording activity made using screen 1000 (e.g., with options 1030 and/or 1050) to the other user equipment device (e.g., directly or through the remote source). For example, control circuitry 304 may receive, from the user, a selection or input to replace the scheduled recording of the video corresponding to the live event with one of the media assets displayed in list 1052 which have not been scheduled for recording. In response to receiving the user selection, control circuitry 304 may generate corresponding instructions for transmission to the other user equipment device to schedule for recording the media asset selected from list 1052 and terminate recording of the video corresponding to the live event.

The other user equipment device may receive the instructions and modify the schedule of recordings based on the inputs control circuitry 304 received on the mobile device.

It should be understood that control circuitry 304 may automatically select an action (e.g., for execution on the other user equipment device) for the video corresponding to the live event without displaying screen 700, 800, 900 and/or 1000. In particular, control circuitry 304 may automatically select an action (e.g., related to any of options 720, 820, 830, 840, 932, 934, 936, 1030, 1040, and/or 1050) to be performed (e.g., on the other user equipment device) instead of (or in addition to) displaying screens 700, 800, 900 and 1000. The action selected by control circuitry 304 may be selected based on a user profile and/or past actions performed by the user for a video corresponding to another media asset that is associated with a live event of a similar type as the live event attended by the user.

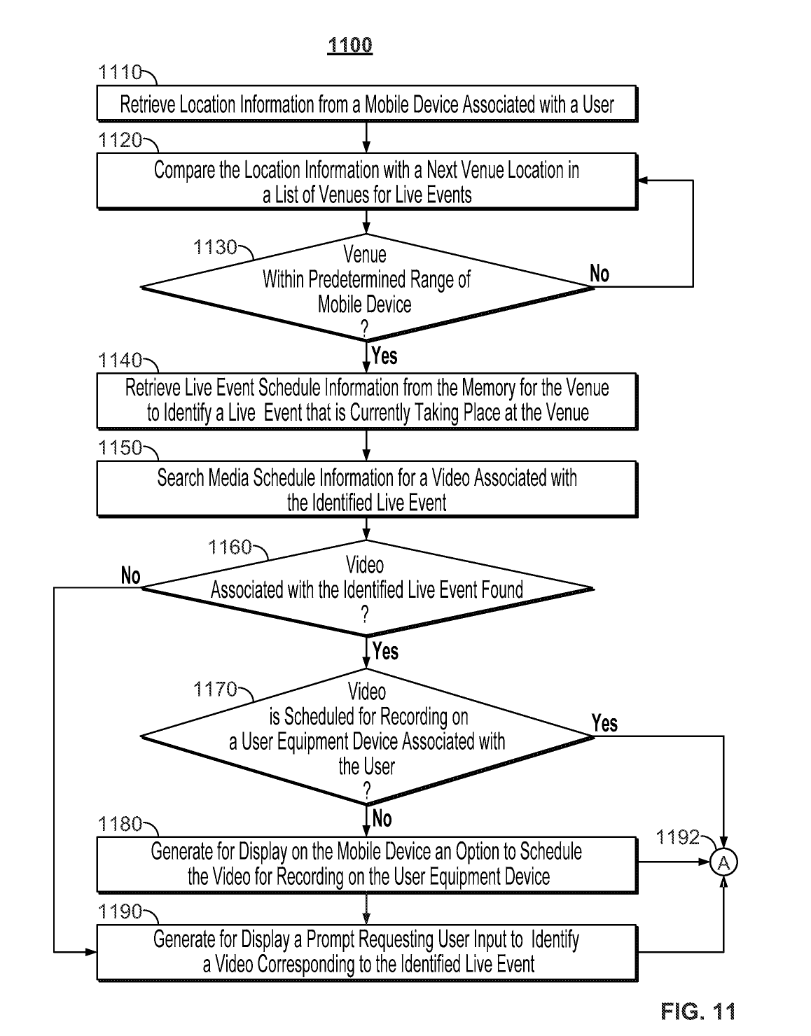

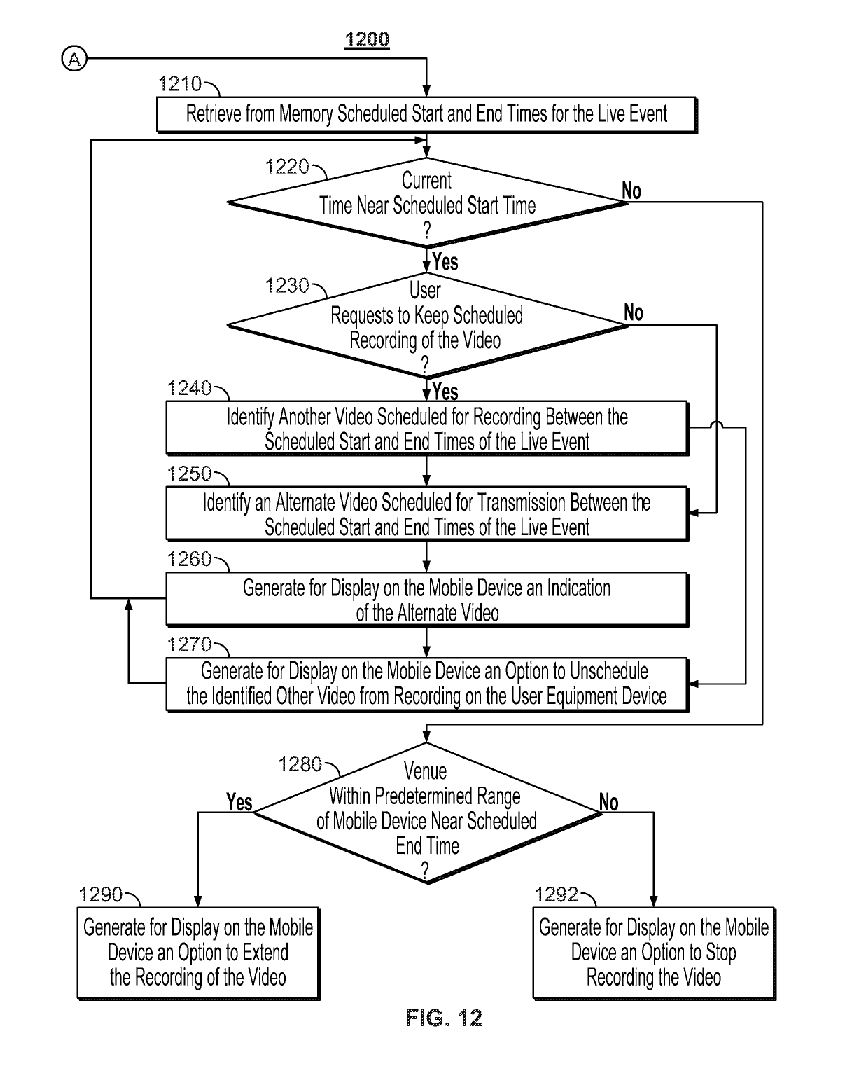

FIGS. 11 and 12 show illustrative flow diagrams 1000 and 1200 for remotely managing recording settings based on a geographical location of a user in accordance with an embodiment of the invention. At step 1110, location information is retrieved from a mobile device associated with a user. The location information may be determined and retrieved in any method discussed above in connection with FIG. 5. For example, control circuitry 304 may retrieve the location information from any combination of a GPS circuitry, social network, calendar, manual entry, and/or triangulation method.

At step 1120, the location information is compared with a next venue location in a list of venues for live events. For example, control circuitry 304 may retrieve venue data structure 600 (FIG. 6) from memory. Control circuitry 304 may compute a difference between the location information and location field 630 and/or the city field 640 to determine the distance between the mobile device and the venue corresponding to the field in venue data structure 600.

At step 1130, a determination is made as to whether the venue is within a predetermined range of the mobile device. In response to determining that the venue is within the predetermined range of the mobile device, the process proceeds to step 1140. Otherwise, the process returns to step 1120 to compare the location information with a next venue in venue data structure 600. For example, control circuitry 304 may determine whether the computed distance is within a predetermined amount (e.g., less than five miles) and if so proceed to step 1140.

At step 1140, live event schedule information is retrieved from memory of the mobile device for the venue to identify a live event that is currently taking place at the venue. For example, control circuitry 304 may retrieve from event fields 650 and 660, live events that are scheduled to take place at the corresponding venue identified in field 620. Control circuitry 304 may identify as the live event being attended by the user, the corresponding event field 640 that is scheduled to take place closest in time to the current time as determined by time field 660.

At step 1150, media asset schedule information is searched to identify a video associated with (or corresponding to) the identified live event. For example, control circuitry 304 may compare a name, date and time of the live event to the name, data and time of a media asset listed in the media asset schedule.

At step 1160, a determination is made as to whether the video associated with the identified live event is found. In response to determining that the video is found, the process proceeds to step 1170, otherwise the process proceeds to step 1190.

At step 1170, a determination is made as to whether the video is scheduled for recording on the other user equipment device associated with the user. In response to determining that the video is scheduled for recording, the process proceeds to step 1192, otherwise the process proceeds to step 1180. For example, control circuitry 304 may transmit a communication to the other user equipment device requesting a list of pending scheduled recordings from the other user equipment device. Control circuitry 304 may analyze the list received from the other user equipment device to determine whether the video is scheduled for recording on the other user equipment device.

At step 1180, an option to schedule the video for recording on the other user equipment device is generated for display on the mobile device. For example, control circuitry 304 may generate for display on the mobile device screen 700 with option 720 (FIG. 7). In response to receiving a user selection of option 720, control circuitry 304 may transmit a communication to the other user equipment device with instructions to schedule the video corresponding to the live event for recording. The communication may cause the other user equipment device to be programmed to schedule the video for recording.

At step 1190, a prompt requesting user input to identify a video corresponding to the identified live event is generated for display on the mobile device. In some implementations, the user may specify the video corresponding to the identified live event by inputting any one or more of the following: title, channel, date, time, category, and/or program ID. In some implementations, the user may search listings display 100 (FIG. 1) for the corresponding video and select one of the interactive listings to identify the video corresponding to the selected listing as corresponding to the live event. Control circuitry 304 may store an indication of the identified video and proceed to step 1192.

At step 1210, scheduled start and end times for the live event are retrieved from a memory of the mobile device. For example, control circuitry 304 may access the media schedule information and retrieve the scheduled broadcast times for the video corresponding to the live event.

At step 1220, a determination is made as to whether the current time is near (e.g., within five to ten minutes of) the scheduled start time. In response to determining that the current time is near the scheduled start time of the video, the process proceeds to step 1230; otherwise the process proceeds to step 1280.

At step 1230, a determination is made as to whether a user request is received to keep the video scheduled for recording on the other user equipment device. In response to determining that the user requests to keep scheduled the recording of the video, the process proceeds to step 1240, otherwise the process proceeds to step 1250. For example, control circuitry 304 may determine whether option 830 (FIG. 8) has been selected by the user.

At step 1240, another video scheduled for recording between the scheduled start and end times of the live event is identified. For example, control circuitry 304 may determine whether there are insufficient resources to record both the video corresponding to the live event and the another video scheduled for recording during the scheduled time of the live event. This determination may occur when the video of the live event was not previously scheduled for recording and the user has been detected at the live event and decided to schedule for recording the video.

At step 1240, an option to un-schedule the identified other video from recording on the other user equipment device is generated for display on the mobile device. For example, control circuitry 304 may generate for display window 730 listing other media assets scheduled for recording during the scheduled time of the video corresponding to the live event.

Control circuitry 304 may receive a user selection from screen 700 to keep the video corresponding to the live event scheduled for recording and un-schedule one of the media assets listed in window 730 to free up resources of the other user equipment device to allow recording of the video corresponding to the live event. Alternatively, the user may instruct control circuitry 304 to un-schedule from recording the video corresponding to the live event and keep unchanged the media asset(s) scheduled for recording that are listed in window 730.

At step 1250, an alternate video(s) scheduled for transmission to the other user equipment device between the scheduled start and end times of the live event is identified. For example, control circuitry 304 may identify the alternate video(s) scheduled for transmission to the other user equipment device based on a preference profile associated with the user. In particular, control circuitry 304 may identify media assets having attributes or characteristics that match the preference profile associated with the user. In some implementations, the alternate video(s) may be related in subject matter to the live event. Control circuitry 304 may identify the alternate videos using any of the methods discussed above in connection with options 840 and 1052 (FIGS. 8 and 10).

At step 1260, an indication of the alternate video(s) is generated for display on the mobile device. For example, control circuitry 304 may display options 840 and 1052 (FIGS. 8 and 10). In response to receiving a user selection of one of the alternate video(s), control circuitry 304 may transmit a communication to the other user equipment device with instructions to schedule for recording the selected alternate video(s) on the other user equipment device. The communication may cause the other user equipment device to be programmed to schedule the alternate video(s) for recording.

At step 1280, a determination is made as to whether the venue is within a predetermined range of the mobile device near the scheduled end time of the live event. In response to determining that the venue is within a predetermined range of the mobile device near the scheduled end time of the live event, the process proceeds to step 1290; otherwise the process proceeds to step 1292. This determination may be made continuously, periodically, or when the current time is within five minutes (or some other predetermined amount of time) of the scheduled end time (e.g., five minutes before or five minutes after the scheduled end time).

At step 1290, an option to extend the recording of the video is generated for display on the mobile device. For example, control circuitry 304 may generate for display option 1030 (FIG. 10). In response to receiving a user selection of option 1030, control circuitry 304, of the mobile device, may instruct the other user equipment device to extend (continue) recording the video corresponding to the live event beyond the scheduled end time by 30 minutes (or some other user specified or automatically determined time).

At step 1292, an option to stop recording the video is generated for display on the mobile device. For example, control circuitry 304 may generate for display option 1040 (FIG. 10). In response to receiving a user selection of option 1040, control circuitry 304 of the mobile device may instruct the other user equipment device to stop recording the video corresponding to the live event before the scheduled end time.

It should be understood that the above steps of the flow diagrams of FIGS. 11 and 12 may be executed or performed in any order or sequence not limited to the order and sequence shown and described in the figures. Also, some of the above steps of the flow diagrams of FIGS. 11 and 12 may be executed or performed substantially simultaneously where appropriate or in parallel to reduce latency and processing times.

The above-described embodiments of the present disclosure are presented for purposes of illustration and not of limitation, and the present disclosure is limited only by the claims which follow.

1. A method for managing video recordings on a user equipment device, the method comprising:
determining that a user, associated with the user equipment device, is currently attending a live event;
identifying, whether a video associated with the live event is accessible by the user equipment device;
in response to the identifying, generating for display on a mobile device an option for the user to select a recording setting for the user equipment device; and
causing the user equipment device to be programmed based on the user selection of the displayed option.

2. The method of claim 1 further comprising:
determining whether the video is scheduled for recording on the user equipment device, wherein the generating for display the option comprises generating an option to schedule the video for recording on the user equipment device in response to determining the video has not been scheduled for recording on the user equipment.

3. The method of claim 1 further comprising:
determining whether the mobile device is within a predetermined range of a venue location of the live event near a scheduled end time of the scheduled transmission, wherein the generating for display the option comprises generating an option to extend a recording of the video on the user equipment device in response to determining that the mobile device is within the predetermined range.

4. The method of claim 1 further comprising:
determining whether the mobile device is within a predetermined range of a venue location of the live event near a scheduled end time of the scheduled transmission; and
in response to determining the mobile device is within the predetermined range near the scheduled end time, automatically extending a recording of the video on another user equipment device associated with a different user.

5. The method of claim 1 further comprising:
determining a number of other mobile devices that are within a predetermined range of a venue location of the live event near a scheduled end time of the scheduled transmission, wherein the generating for display the option comprises generating an option to extend a recording of the video on the user equipment device based on the number of other mobile devices within the predetermined range.

6. The method of claim 5 further comprising computing a number that represents how many of the other mobile devices are within the predetermined range near a scheduled start time of the scheduled transmission, wherein the number of other mobile devices within the predetermined range is greater than half of the computed number.

7. The method of claim 1, wherein determining that the user is currently attending the live event comprises:
retrieving location information from the mobile device;
cross-referencing the location information with a list of venues for live events to identify a venue within a predetermined range of a location of the mobile device; and
retrieving live event schedule information for the identified venue to identify a live event currently in progress as the live event attended by the user.

8. The method of claim 7 further comprising generating a message for display on the mobile device indicating the identified live event, wherein the message includes a selectable option to confirm the user is currently attending the live event indicated by the message.

9. The method of claim 1, wherein determining that the user is currently attending the live event comprises:
retrieving, from a social network, status information corresponding to the user or corresponding to members associated with the user; and
processing the status information to identify the live event currently in attendance by the user.

10. The method of claim 1, wherein the video is a first video, and wherein generating the option for display comprises:
determining whether the first video is scheduled for recording on the user equipment device; and
identifying a second video that is scheduled for transmission to the user equipment device at the time the first video is scheduled for transmission;
wherein the option includes an option to schedule the second video for recording in place of the first video.

11. A system for managing video recordings on a user equipment device, the system comprising:
control circuitry configured to:
determine that a user, associated with the user equipment device, is currently attending a live event;
identify, whether a video associated with the live event is accessible by the user equipment device;
in response to the identifying, generate for display on a mobile device an option for the user to select a recording setting for the user equipment device; and
cause the user equipment device to be programmed based on the user selection of the displayed option.

12. The system of claim 11, wherein the control circuitry is further configured to:
determine whether the video is scheduled for recording on the user equipment device; and
generate an option to schedule the video for recording on the user equipment device in response to determining the video has not been scheduled for recording on the user equipment.

13. The system of claim 11, wherein the control circuitry is further configured to:
determine whether the mobile device is within a predetermined range of a venue location of the live event near a scheduled end time of the scheduled transmission; and
generate an option to extend a recording of the video on the user equipment device in response to determining that the mobile device is within the predetermined range.

14. The system of claim 11, wherein the control circuitry is further configured to:
determine whether the mobile device is within a predetermined range of a venue location of the live event near a scheduled end time of the scheduled transmission; and
in response to determining the mobile device is within the predetermined range near the scheduled end time, automatically extend a recording of the video on another user equipment device associated with a different user.

15. The system of claim 11, wherein the control circuitry is further configured to:
determine a number of other mobile devices that are within a predetermined range of a venue location of the live event near a scheduled end time of the scheduled transmission; and generate an option to extend a recording of the video on the user equipment device based on the number of other mobile devices within the predetermined range.

16. The system of claim 15, wherein the control circuitry is further configured to compute a number that represents how many of the other mobile devices are within the predetermined range near a scheduled start time of the scheduled transmission, wherein the number of other mobile devices within the predetermined range is greater than half of the computed number.

17. The system of claim 11, wherein the control circuitry is further configured to:
retrieve location information from the mobile device;
cross-reference the location information with a list of venues for live events to identify a venue within a predetermined range of a location of the mobile device; and
retrieve live event schedule information for the identified venue to identify a live event currently in progress as the live event attended by the user.

18. The system of claim 17, wherein the control circuitry is further configured to: generate a message for display on the mobile device indicating the identified live event, wherein the message includes a selectable option to confirm the user is currently attending the live event indicated by the message.

19. The system of claim 11, wherein the control circuitry is further configured to:
retrieve, from a social network, status information corresponding to the user or corresponding to members associated with the user; and
process the status information to identify the live event currently in attendance by the user.

20. The system of claim 11, wherein the video is a first video, and wherein the control circuitry is further configured to:
determine whether the first video is scheduled for recording on the user equipment device; and
identify a second video that is scheduled for transmission to the user equipment device at the time the first video is scheduled for transmission;
wherein the option includes an option to schedule the second video for recording in place of the first video.

21-30. (canceled)
